(19) United States
(12) Patent Application Publication
(10) Pub. No.: US 2026/0209134 A1
(43) Pub. Date: Jul. 23, 2026

(54) GROWTH-PROMOTING AND STRESS-RESISTANT WATER-SOLUBLE FERTILIZER FOR IMPROVING YIELD AND QUALITY OF PROTECTED-CULTURE TOMATOES AND PREPARATION METHOD THEREFOR

(71) Applicant: Shandong Academy of Agricultural Sciences, Jinan (CN)

(72) Inventors: Luji Bo, Jinan (CN); Yan Li, Jinan (CN); Zhaohui Liu, Jinan (CN); Xiao Yan, Jinan (CN)

(21) Appl. No.: 19/298,176

(22) Filed: Aug. 12, 2025

(30) Foreign Application Priority Data
Jan. 17, 2025 (CN) 202510074814.8

(51) Int. Cl. C05F 11/02; A01C 21/00; A01G 22/05; C05B 7/00; C05C 3/00; C05C 9/00; C05D 1/02; C05D 3/00; C05D 5/00; C05D 9/02; C05G 5/23

(52) U.S. Cl. CPC C05F 11/02; A01C 21/005; A01G 22/05; C05B 7/00; C05C 3/00; C05C 9/00; C05D 1/02; C05D 3/00; C05D 5/00; C05D 9/02; C05G 5/23

(57) ABSTRACT

A growth-promoting and stress-resistant water-soluble fertilizer for improving yield and quality of protected-culture tomatoes and a preparation method thereof are provided. The growth-promoting and stress-resistant water-soluble fertilizer includes the following components in parts by weight: 20-30 parts of soluble humate, 35-40 parts of urea, 3-6 parts of potassium dihydrogen phosphate, 48-55 parts of potassium sulfate, 1.5-2.5 parts of zinc sulfate, 1.8-2.2 parts of magnesium sulfate, 1.8-2.2 parts of calcium chloride, 0.1-0.2 parts of boric acid, 0.5-0.7 parts of ammonium molybdate, 0.4-0.6 parts of ferrous sulfate, 13-18 parts of EDTA, and 5-8 parts of polyaspartic acid. The growth-promoting and stress-resistant water-soluble fertilizer can meet demand of tomatoes for macro-elements and medium-to-microelements during a growth stage, help raise soil temperature, and improve the yield and quality of the protected-culture tomatoes in northern regions during winter when used in combination with chitosan cross-linked humic acid.

### CROSS-REFERENCE TO RELATED APPLICATION

This application claims priority to Chinese Patent Application No. 202510074814.8 filed on Jan. 17, 2025, which is herein incorporated by reference in its entirety.

### TECHNICAL FIELD

The disclosure relates to the technical field of water-soluble fertilizers, and more particularly to a growth-promoting and stress-resistant water-soluble fertilizer for improving yield and quality of protected-culture tomatoes and a preparation method thereof.

### BACKGROUND

Protected cultivation technology is a modern agricultural planting method that uses greenhouses, plastic greenhouses or other facilities to regulate crop production by changing or controlling environmental factors (such as light, temperature, moisture, carbon dioxide, etc.) affecting crop growth and development. The protected cultivation technology is mainly used to provide people with fresh, high-quality, out-of-season, overtime, and pollution-free products and has advantages of high yield, excellent quality, and high price in off-season of products.

Water-soluble fertilizers, as a new type of environmentally friendly fertilizers, have comprehensive nutritional elements, usually referring to fertilizers that can be completely dissolved in water, including: single-element water-soluble fertilizers of macronutrients, compound water-soluble fertilizers, water-soluble fertilizers specified by the Ministry of Agriculture and Rural Affairs, and organic water-soluble fertilizers, such as nitrogen, phosphorus, potassium, calcium, magnesium, microelements, amino acid, humic acid, alginic acid, etc.

The water-soluble fertilizers can be divided into nutritional water-soluble fertilizers and functional water-soluble fertilizers according to different functions. The nutritional water-soluble fertilizers are mainly used to supplement nutrients needed for crop growth, including macro-element water-soluble fertilizers, medium-element water-soluble fertilizers and microelement water-soluble fertilizers. The functional water-soluble fertilizers are added with functional active substances such as plant sources, animal sources, and mineral sources, including the organic water-soluble fertilizers containing the humic acid, the amino acid and the alginic acid, and the functional fertilizers can improve soil, stimulate crop growth and improve crop quality.

Tomatoes are thermophilic vegetables. Under normal conditions, an optimal temperature for assimilation of the tomatoes is in a range of 20 degrees Celsius (° C.) to 25° C., and an optimal soil temperature for root growth of the tomatoes is in a range of 20° C. to 22° C. Although the protected cultivation technology provides certain conditions for tomato cultivation, cold climate in northern regions still seriously limits production of out-of-season protected-culture tomatoes. Among them, growth obstacles caused by low-temperature environment, such as slow plant growth, difficult fruit growth, and poor fruit quality, have become important limiting factors for production of the protected-culture tomatoes, seriously affecting a yield of the protected-culture tomatoes and reducing economic benefits. Therefore, it is particularly necessary to develop a water-soluble fertilizer that can promote growth and fruiting of the protected-culture tomatoes under cold conditions.

### SUMMARY

The disclosure aims to provide a growth-promoting and stress-resistant water-soluble fertilizer for improving yield and quality of protected-culture tomatoes and a preparation method thereof to solve a problem of low yield and poor quality of the protected-culture tomatoes in winter and spring.

To achieve the aforementioned objectives, the disclosure provides the following technical solutions.

The growth-promoting and stress-resistant water-soluble fertilizer for improving the yield and quality of the protected-culture tomatoes provided by an embodiment of the disclosure includes the following components in parts by weight: 20-30 parts of soluble humate, 35-40 parts of urea, 3-6 parts of potassium dihydrogen phosphate, 48-55 parts of potassium sulfate, 1.5-2.5 parts of zinc sulfate, 1.8-2.2 parts of magnesium sulfate, 1.8-2.2 parts of calcium chloride, 0.1-0.2 parts of boric acid, 0.5-0.7 parts of ammonium molybdate, 0.4-0.6 parts of ferrous sulfate, 13-18 parts of ethylene diamine tetraacetic acid (EDTA), and 5-8 parts of polyaspartic acid. The soluble humate includes at least one of sodium humate and potassium humate.

The preparation method of the growth-promoting and stress-resistant water-soluble fertilizer provided by another embodiment of the disclosure includes the following steps:
S1, mixing the urea, the potassium dihydrogen phosphate, the potassium sulfate, the zinc sulfate, the magnesium sulfate, the calcium chloride, the boric acid, the ammonium molybdate, the ferrous sulfate, and the EDTA with 100-120 parts of water, followed by stirring for dissolving to obtain a first solution;
S2, mixing the first solution with the polyaspartic acid and the soluble humate, followed by stirring at a first stirring speed in a range of 600 revolutions per minute (rpm) to 800 rpm and a first stirring temperature in a range of 55° C. to 65° C. for 20 minutes (min) to 30 min, to obtain a second solution; and
S3, homogenizing the second solution at a homogenizing temperature in a range of 55° C. to 65° C. under a pressure in a range of 220 megapascal (MPa) to 240 MPa for 30 min to 50 min to obtain a homogenized solution, and concentrating the homogenized solution for crystallization followed by spray drying to obtain the growth-promoting and stress-resistant water-soluble fertilizer.

The growth-promoting and stress-resistant water-soluble fertilizer provided by the disclosure can meet demand of tomatoes for nitrogen, phosphorus, potassium, and medium-to-microelements during a fruit-setting stage in the winter and spring. The soluble humate contained in the growth-promoting and stress-resistant water-soluble fertilizer has effects of improving soil, raising soil temperature, and promoting root growth. The polyaspartic acid can not only improve stress resistance of the tomatoes, but also cooperate with soluble humic acid to raise the soil temperature.

A method for preparing a chitosan cross-linked humic acid provided by still another embodiment of the disclosure includes the following steps: dissolving chitosan in an acetic acid solution to obtain a third solution, adding glutaraldehyde and humic acid to the third solution followed by stirring at a second stirring speed in a range of 4000 rpm to 5000 rpm and a second stirring temperature in a range of 60° C. to 70° C. for 2.5 hours (h) to 3 h to obtain a first mixture, adding the first mixture dropwise into a sodium hydroxide (NaOH) solution followed by standing to obtain a second mixture, centrifuging the second mixture to obtain a precipitate, and collecting the precipitate to thereby obtain the chitosan cross-linked humic acid.

In an embodiment, a volume percentage of the acetic acid solution is in a range of 4% to 6%, and a weight-to-volume ratio of the chitosan to the acetic acid solution is 1 gram (g):(10-15) milliliters (mL).

In an embodiment, a weight-to-volume ratio of the chitosan to the glutaraldehyde is 1 g:(0.3-0.35) mL, and a weight ratio of the chitosan to the humic acid is 1:(2-3).

In an embodiment, a concentration of the NaOH solution is in a range of 0.15 moles per liter (mol/L) to 0.25 mol/L.

The glutaraldehyde is a crosslinking agent. The chitosan cross-linked humic acid prepared in the disclosure has a loose and porous structure, thereby swelling after absorbing water. The chitosan cross-linked humic acid can use the water absorbed to retain part of heat energy generated by daytime light to regulate nighttime temperature, thereby helping reduce soil temperature difference between day and night and improving stability of the soil temperature.

The disclosure further provides the chitosan cross-linked humic acid prepared by the method for preparing the chitosan cross-linked humic acid.

A cultivation method for improving the yield and quality of the protected-culture tomatoes in the winter and spring provided by yet another embodiment of the disclosure includes the following steps:
(1) applying 800 kilograms (kg) to 1000 kg of an organic fertilizer and 20 kg to 30 kg of the chitosan cross-linked humic acid per acre before tomato planting;
(2) applying 7 kg to 8 kg of the urea per acre after tomato seedlings have acclimated after transplanting; and
(3) dissolving the growth-promoting and stress-resistant water-soluble fertilizer in the water to obtain a fertilizer solution, and performing drip irrigation with the fertilizer solution during the fruit-setting stage of the tomatoes.

In an embodiment, a weight-to-volume ratio of the growth-promoting and stress-resistant water-soluble fertilizer to the water is 1 kg:(100-120) liters (L).

In an embodiment, a usage amount of the growth-promoting and stress-resistant water-soluble fertilizer is in a range of 50 kg to 60 kg.

By using the aforementioned technical solutions, the disclosure has the following beneficial effects. The growth-promoting and stress-resistant water-soluble fertilizer provided by the disclosure has the following components in parts by weight: 20-30 parts of the soluble humate, 35-40 parts of the urea, 3-6 parts of the potassium dihydrogen phosphate, 48-55 parts of the potassium sulfate, 1.5-2.5 parts of the zinc sulfate, 1.8-2.2 parts of the magnesium sulfate, 1.8-2.2 parts of the calcium chloride, 0.1-0.2 parts of the boric acid, 0.5-0.7 parts of the ammonium molybdate, 0.4-0.6 parts of the ferrous sulfate, 13-18 parts of the EDTA, and 5-8 parts of the polyaspartic acid. The growth-promoting and stress-resistant water-soluble fertilizer can meet the demand of the tomatoes for macro-elements and medium-to-microelements during a growth stage, help raise the soil temperature, and improve the yield and quality of the protected-culture tomatoes in northern regions during the winter when used in combination with the chitosan cross-linked humic acid prepared by the disclosure.

### DETAILED DESCRIPTION OF EMBODIMENTS

Technical solutions provided by the disclosure will be described in detail with reference to embodiments, but the embodiments should not be regarded as limiting a scope of protection of the disclosure.

### Embodiment 1

A growth-promoting and stress-resistant water-soluble fertilizer is prepared by the following steps S1 through S3.
S1, 35 kg of urea, 3 kg of potassium dihydrogen phosphate, 48 kg of potassium sulfate, 1.5 kg of zinc sulfate, 1.8 kg of magnesium sulfate, 1.8 kg of calcium chloride, 0.1 kg of boric acid, 0.5 kg of ammonium molybdate, 0.4 kg of ferrous sulfate, and 13 kg of EDTA are mixed with 100 L of water and then stirred for dissolving to obtain a first solution.
S2, the first solution is mixed with 5 kg of polyaspartic acid and 20 kg of sodium humate and then stirred at a first stirring speed of 600 rpm and a first stirring temperature of 55° C. for 30 min to obtain a second solution.
S3, the second solution is homogenized at a homogenizing temperature of 55° C. under a pressure of 220 MPa for 50 min to obtain a homogenized solution. The homogenized solution is concentrated for crystallization and then spray dried to obtain the growth-promoting and stress-resistant water-soluble fertilizer.

### Embodiment 2

A growth-promoting and stress-resistant water-soluble fertilizer is prepared by the following steps S1 through S3.
S1, 38 kg of urea, 5 kg of potassium dihydrogen phosphate, 52 kg of potassium sulfate, 2 kg of zinc sulfate, 2 kg of magnesium sulfate, 2 kg of calcium chloride, 0.15 kg of boric acid, 0.6 kg of ammonium molybdate, 0.5 kg of ferrous sulfate, and 15 kg of EDTA are mixed with 110 kg of water and then stirred for dissolving to obtain a first solution.
S2, the first solution is mixed with 6 kg of polyaspartic acid and 25 kg of sodium humate and then stirred at a first stirring speed of 700 rpm and a first stirring temperature of 60° C. for 25 min to obtain a second solution.
S3, the second solution is homogenized at a homogenizing temperature of 60° C. under a pressure of 230 MPa for 40 min to obtain a homogenized solution. The homogenized solution is concentrated for crystallization and then spray dried to obtain the growth-promoting and stress-resistant water-soluble fertilizer.

### Embodiment 3

A growth-promoting and stress-resistant water-soluble fertilizer is prepared by the following steps S1 through S3.
S1, 40 kg of urea, 6 kg of potassium dihydrogen phosphate, 55 kg of potassium sulfate, 2.5 kg of zinc sulfate, 2.2 kg of magnesium sulfate, 2.2 kg of calcium chloride, 0.2 kg of boric acid, 0.7 kg of ammonium molybdate, 0.6 kg of ferrous sulfate, and 18 kg of EDTA are mixed with 120 kg of water and then stirred for dissolving to obtain a first solution.
S2, the first solution is mixed with 8 kg of polyaspartic acid and 30 kg of sodium humate and then stirred at a first stirring speed of 800 rpm and a first stirring temperature of 65° C. for 20 min to obtain a second solution.
S3, the second solution is homogenized at a homogenizing temperature of 65° C. under a pressure of 240 MPa for 30 min to obtain a homogenized solution. The homogenized solution is concentrated for crystallization and then spray dried to obtain the growth-promoting and stress-resistant water-soluble fertilizer.

### Embodiment 4

A chitosan cross-linked humic acid is prepared by the following steps. 1 kg of chitosan is dissolved in 12 L of acetic acid solution with a volume fraction of 5% to obtain a third solution. 0.5 L of glutaraldehyde and 2 kg of humic acid powder are added to the third solution and then stirred at a second stirring speed of 5000 rpm for 3 h to obtain a paste (i.e., a first mixture). The paste is added by a peristaltic pump dropwise into an NaOH solution with a concentration of 0.2 mol/L placed on a magnetic stirrer, in which a rotating speed of the magnetic stirrer is 800 rpm, and then stood for 24 h to obtain a second mixture. The second mixture is centrifuged at a centrifugating speed of 4000 rpm to obtain a precipitate. The precipitate is collected and then washed for 2-3 times to obtain the chitosan cross-linked humic acid.

### Comparative Embodiment 1

A water-soluble fertilizer does not contain a polyaspartic acid.

### Comparative Embodiment 2

A chitosan is replaced with a fermented straw powder to prepare a cellulose cross-linked humic acid.

### Experimental Embodiment 1

An experiment is conducted at a large-area cropland in Guanlu Village, Shouguang City, Shandong Province, on Dec. 15, 2023. A variety of tomatoes is Dafnis (bred by Syngenda Group, China). Each treatment group occupies a separate greenhouse. Each greenhouse has an area of 667 square meters (m²). In each greenhouse, a row spacing between tomato seedlings is 50 centimeters (cm), and a plant spacing between the tomato seedlings is 30 cm. The experiment is divided into 9 treatment groups.
Treatment group 1: 1000 kg of an organic fertilizer and 25 kg of the chitosan cross-linked humic acid prepared in embodiment 4 are applied per acre and soil in the greenhouse is rotary tilled to a depth of 15 cm before tomato planting; 8 kg of urea is applied per acre after the tomato seedlings have acclimated after transplanting; and the growth-promoting and stress-resistant water-soluble fertilizer prepared in embodiment 1 is dissolved in water according to a weight-to-volume of 1 kg:120 L for drip irrigation during a fruit-setting stage of the tomatoes.
Treatment group 2: 1000 kg of the organic fertilizer and 25 kg of the chitosan cross-linked humic acid prepared in embodiment 4 are applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in embodiment 2 is dissolved in the water according to the weight-to-volume ratio of 1 kg:120 L for drip irrigation during the fruit-setting stage of the tomatoes.
Treatment group 3: 1000 kg of the organic fertilizer and 25 kg of the chitosan cross-linked humic acid prepared in embodiment 4 are applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in embodiment 3 is dissolved in the water according to the weight-to-volume ratio of 1 kg:120 L for drip irrigation during the fruit-setting stage of the tomatoes.
Treatment group 4: 1000 kg of the organic fertilizer and 25 kg of the chitosan cross-linked humic acid prepared in embodiment 4 are applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in comparative embodiment 1 is dissolved in the water according to the weight-to-volume ratio of 1 kg:120 L for drip irrigation during the fruit-setting stage of the tomatoes.
Treatment group 5: 1000 kg of the organic fertilizer and 25 kg of the chitosan cross-linked humic acid prepared in embodiment 4 are applied per acre and the soil in the greenhouse is rotary tilled to the depth of 15 cm before the tomato planting; 8 kg of the urea is applied per acre after the tomato seedlings have acclimated after transplanting; and a commercially available Staley® Liguo water-soluble fertilizer is dissolved in the water according to the weight-to-volume ratio of 1 kg:120 L for drip irrigation during the fruit-setting stage of the tomatoes.
Treatment group 6: 1000 kg of the organic fertilizer and 25 kg of the cellulose cross-linked humic acid prepared in comparative embodiment 2 are applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in embodiment 1 is dissolved in the water according to the weight-to-volume ratio of 1 kg:120 L for drip irrigation during the fruit-setting stage of the tomatoes.
Treatment group 7: 1000 kg of the organic fertilizer is applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in embodiment 1 is dissolved in the water according to the weight-to-volume ratio of 1 kg:120 L for drip irrigation during the fruit-setting stage of the tomatoes.
Treatment group 8: 1000 kg of the organic fertilizer is applied per acre and the soil in the greenhouse is rotary tilled to the depth of 15 cm before the tomato planting; 8 kg of the urea is applied per acre after the tomato seedlings have acclimated after transplanting; and the growth-promoting and stress-resistant water-soluble fertilizer prepared in comparative embodiment 1 is dissolved in the water according to the weight-to-volume ratio of 1 kg:120 L for drip irrigation during the fruit-setting stage of the tomatoes.
Treatment group 9: 1000 kg of the organic fertilizer is applied per acre and the soil in the greenhouse is rotary tilled to the depth of 15 cm before the tomato planting; 8 kg of the urea is applied per acre after the tomato seedlings have acclimated after transplanting; and the commercially available Staley® Liguo water-soluble fertilizer is dissolved in the water according to the weight-to-volume ratio of 1 kg:120 L for drip irrigation during the fruit-setting stage of the tomatoes.

The organic fertilizer in each treatment group is a Zhuangfangyuan® organic fertilizer, in which a sum of weight percentages of nitrogen, phosphorus oxide, and potassium oxide is equal to or larger than 4%, and a weight percentage of organic matter is equal to or larger than 30%.

Soil temperatures at a depth of 10 cm are measured at 10:00 ante meridiem in each treatment group on Dec. 20, 2023 (after application of base fertilizer, no water-soluble fertilizer) and Jan. 30, 2024 (after application of the water-soluble fertilizer). During a tomato harvest stage, a yield per acre and a percentage of first-class fruits of each treatment group are recorded. Results are shown in Table 1. The first-class fruits are tomato fruits pink in color with no cracks and obvious defects on surfaces thereof.

TABLE 1
soil temperatures and tomato harvest of each treatment group

| | soil | soil | | |
|---|---|---|---|---|
| | temperature | temperature | yield | percentage |
| | on December | on January | per acre | of first-class |
| treatment group | 20 (° C.) | 30 (° C.) | (kg) | fruits (%) |
| treatment group 1 | 20.9 | 21.5 | 6347.3 | 86.0 |
| treatment group 2 | 21.7 | 22.1 | 6415.6 | 83.4 |
| treatment group 3 | 21.3 | 22.3 | 6386.2 | 85.7 |
| treatment group 4 | 21.5 | 18.5 | 5835.7 | 60.3 |
| treatment group 5 | 21.4 | 17.5 | 5765.1 | 52.1 |
| treatment group 6 | 20.3 | 18.3 | 5723.2 | 48.62 |
| treatment group 7 | 19.1 | 17.4 | 5405.8 | 43.9 |
| treatment group 8 | 19.4 | 16.1 | 5241.6 | 38.6 |
| treatment group 9 | 19.3 | 15.4 | 5150.5 | 35.2 |

It can be seen from table 1 that the soil temperatures of treatment groups 1-5 are higher than that of treatment groups 7-9 on December 20, indicating that the chitosan cross-linked humic acid provided by the disclosure can raise a soil temperature. The soil temperatures of treatment groups 1-5 are higher than that of treatment group 6 on December 20, indicating that thermal insulation performance of the chitosan cross-linked humic acid prepared in the disclosure is higher than that of the cellulose cross-linked humic acid prepared in comparative embodiment 2.

It can be seen from the soil temperatures of treatment group 7 and treatment group 9 on December 20 that the growth-promoting and stress-resistant water-soluble fertilizer provided by the disclosure has an effect of raising the soil temperature. It can be seen from the soil temperatures of treatment groups 7-8 on January 30 that the effect of raising the soil temperature of the growth-promoting and stress-resistant water-soluble fertilizer provided by the disclosure is better than that of the water-soluble fertilizer prepared in comparative embodiment 1, indicating that adding the polyaspartic acid to the water-soluble fertilizer can improve a warming effect of the soluble humate on soil. The yields per acre of the potatoes and the percentages of first-class fruits of treatment groups 1-5 are better than those of treatment groups 7-9, because treatment groups 7-9 are not applied with the chitosan cross-linked humic acid before the tomato planting, causing the soil temperatures to be relatively low, thereby affecting development of the tomato seedlings and resulting in low yields per acre of the potatoes and low percentages of first-class fruits.

The chitosan cross-linked humic acid is applied during applying the base fertilizer due to its insolubility in the water. Applying the growth-promoting and stress-resistant water-soluble fertilizer via drip irrigation during the fruit-setting stage of the tomatoes can further raise the soil temperature to provide a suitable temperature for tomato growth.

Contents of soluble solids, vitamin C, and organic acids in mature tomatoes harvested from the treatment groups 1-9 are measured, and measuring results are shown in table 2.

TABLE 2
contents of soluble solids, vitamin C, and organic acids
in mature tomatoes harvested from treatment groups 1-9

| | vitamin C (milligrams | organic | soluble |
|---|---|---|---|
| | per hundred grams, | acids | solids |
| treatment group | abbreviated as mg/100 g) | (mg/100 g) | (%) |
| treatment group 1 | 58.19 | 65.12 | 5.88 |
| treatment group 2 | 56.37 | 62.59 | 5.64 |
| treatment group 3 | 56.22 | 63.37 | 5.71 |
| treatment group 4 | 52.14 | 58.06 | 5.52 |
| treatment group 5 | 45.73 | 47.81 | 4.71 |
| treatment group 6 | 47.25 | 50.12 | 4.89 |
| treatment group 7 | 52.46 | 55.23 | 5.31 |
| treatment group 8 | 50.28 | 51.66 | 5.06 |
| treatment group 9 | 41.22 | 45.18 | 4.43 |

It can be seen from table 2 that the contents of soluble solids, vitamin C, and organic acids in the mature tomatoes harvested from the treatment groups 1-3 are higher than those in the mature potatoes harvested from the treatment groups 4-9, indicating that applying the chitosan cross-linked humic acid during applying the base fertilizer and applying the growth-promoting and stress-resistant water-soluble fertilizer provided by the disclosure during the fruit-setting stage of the tomatoes are beneficial for improving tomato taste and quality.

As can be seen from the aforementioned embodiments, the disclosure provides the growth-promoting and stress-resistant water-soluble fertilizer for improving the yield and quality of greenhouse tomatoes and the preparation method therefor. The growth-promoting and stress-resistant water-soluble fertilizer can raise soil temperatures of greenhouses in northern regions and improve the yield and quality of the protected-culture potatoes when used in combination with the chitosan cross-linked humic acid.

The aforementioned embodiments are merely part of embodiments of the disclosure. It should be noted that, for those skilled in the art, several improvements and embellishments can be made to the embodiments of the disclosure without departing from principles of the disclosure, and these improvements and embellishments shall fall within the scope of protection of the disclosure.

What is claimed is:

1. A growth-promoting and stress-resistant water-soluble fertilizer for improving yield and quality of protected-culture tomatoes, comprising the following components in parts by weight: 20-30 parts of soluble humate, 35-40 parts of urea, 3-6 parts of potassium dihydrogen phosphate, 48-55 parts of potassium sulfate, 1.5-2.5 parts of zinc sulfate, 1.8-2.2 parts of magnesium sulfate, 1.8-2.2 parts of calcium chloride, 0.1-0.2 parts of boric acid, 0.5-0.7 parts of ammonium molybdate, 0.4-0.6 parts of ferrous sulfate, 13-18 parts of ethylene diamine tetraacetic acid (EDTA), and 5-8 parts of polyaspartic acid; wherein the soluble humate comprises at least one of sodium humate and potassium humate.

2. A preparation method of the growth-promoting and stress-resistant water-soluble fertilizer as claimed in claim 1, comprising the following steps:
S1, mixing the urea, the potassium dihydrogen phosphate, the potassium sulfate, the zinc sulfate, the magnesium sulfate, the calcium chloride, the boric acid, the ammonium molybdate, the ferrous sulfate, and the EDTA with 100-120 parts of water, followed by stirring for dissolving to obtain a first solution;
S2, mixing the first solution with the polyaspartic acid and the soluble humate, followed by stirring at a first stirring speed in a range of 600 revolutions per minute (rpm) to 800 rpm and a first stirring temperature in a range of 55 degrees Celsius (° C.) to 65° C. for 20 minutes (min) to 30 min, to obtain a second solution; and
S3, homogenizing the second solution at a homogenizing temperature in a range of 55° C. to 65° C. under a pressure in a range of 220 megapascal (MPa) to 240 MPa for 30 min to 50 min to obtain a homogenized solution, and concentrating the homogenized solution for crystallization followed by spray drying to obtain the growth-promoting and stress-resistant water-soluble fertilizer.

3. A method for preparing a chitosan cross-linked humic acid, comprising the following steps: dissolving chitosan in an acetic acid solution to obtain a third solution, adding glutaraldehyde and humic acid to the third solution followed by stirring at a second stirring speed in a range of 4000 rpm to 5000 rpm and a second stirring temperature in a range of 60° C. to 70° C. for 2.5 hours (h) to 3 h to obtain a first mixture, adding the first mixture dropwise into a sodium hydroxide (NaOH) solution followed by standing to obtain a second mixture, centrifuging the second mixture to obtain a precipitate, and collecting the precipitate to thereby obtain the chitosan cross-linked humic acid.

4. The method for preparing the chitosan cross-linked humic acid as claimed in claim 3, wherein a volume percentage of the acetic acid solution is in a range of 4% to 6%, and a weight-to-volume ratio of the chitosan to the acetic acid solution is 1 gram (g):(10-15) milliliters (mL).

5. The method for preparing the chitosan cross-linked humic acid as claimed in claim 3, wherein a weight-to-volume ratio of the chitosan to the glutaraldehyde is 1 g:(0.3-0.35) mL, and a weight ratio of the chitosan to the humic acid is 1:(2-3).

6. The method for preparing the chitosan cross-linked humic acid as claimed in claim 3, wherein a concentration of the NaOH solution is in a range of 0.15 moles per liter (mol/L) to 0.25 mol/L.

7. A chitosan cross-linked humic acid, prepared by the method for preparing the chitosan cross-linked humic acid as claimed in claim 3.

8. A cultivation method for improving yield and quality of protected-culture tomatoes in winter and spring, comprising the following steps:
(1) applying 800 kilograms (kg) to 1000 kg of an organic fertilizer and 20 kg to 30 kg of the chitosan cross-linked humic acid as claimed in claim 7 per acre before tomato planting;
(2) applying 7 kg to 8 kg of urea per acre after tomato seedlings have acclimated after transplanting; and
(3) dissolving a growth-promoting and stress-resistant water-soluble fertilizer in water to obtain a fertilizer solution, and performing drip irrigation with the fertilizer solution during a fruit-setting stage of tomatoes;
wherein the growth-promoting and stress-resistant water-soluble fertilizer comprises the following components in parts by weight: 20-30 parts of soluble humate, 35-40 parts of urea, 3-6 parts of potassium dihydrogen phosphate, 48-55 parts of potassium sulfate, 1.5-2.5 parts of zinc sulfate, 1.8-2.2 parts of magnesium sulfate, 1.8-2.2 parts of calcium chloride, 0.1-0.2 parts of boric acid, 0.5-0.7 parts of ammonium molybdate, 0.4-0.6 parts of ferrous sulfate, 13-18 parts of EDTA, and 5-8 parts of polyaspartic acid; wherein the soluble humate comprises at least one of sodium humate and potassium humate.

9. The cultivation method as claimed in claim 8, wherein a weight-to-volume ratio of the growth-promoting and stress-resistant water-soluble fertilizer to the water is 1 kg:(100-120) liters (L).

10. The cultivation method as claimed in claim 8, wherein a usage amount of the growth-promoting and stress-resistant water-soluble fertilizer is in a range of 50 kg to 60 kg.
